(19) United States
(12) Patent Application Publication
(10) Pub. No.: US 2014/0046695 A1
(43) Pub. Date: Feb. 13, 2014

(54) Device, method, and system for the automated compilation and processing of vital data

(71) Applicant: MT2IT GmbH & Co. KG, Ratzeburg (DE)

(72) Inventor: Joerg-Uwe Meyer, Ratzeburg (DE)

(73) Assignee: MT2IT GmbH & Co. KG, Ratzeburg (DE)

(21) Appl. No.: 13/962,727

(22) Filed: Aug. 8, 2013

(30) Foreign Application Priority Data
Aug. 10, 2012 (DE) 10 2012 015 808.4

(51) Int. Cl. G06F 19/00

(52) U.S. Cl. CPC G06F 19/322
USPC 705/3

(57) ABSTRACT

Vital data management system (VDMS), for example a patient data management system (PDMS), comprising a VDMS web application (1) of a run-time environment, and also corresponding devices, methods, systems and computer program products for IT-based vital data management, for example patient data management, and for automated compilation and processing of vital data.

### FIELD OF THE INVENTION

The present invention focuses the fields of medical engineering and information technology and in particular relates to the automated compilation and processing of vital data, for example patient data, or other systems, for example vital data management systems (VDMSs) and patient data management systems (PDMSs).

### PRIOR ART

PDMSs are computerised information systems in health informatics and compile, represent and manage patient-based information in the form of data in hospitals. A distinction is made between PDMSs as part of a superordinate hospital or clinical information system (CIS) for managing and processing patient and case data and PDMSs as information systems in a clinical workstation for dealing with tasks concerning the treatment and care of patients.

Routine administrative tasks of a CIS include admission, relocation and discharge of patients, medical and care-related basic documentation, printing and reading of labels, forms and barcodes, compilation of bill-relevant data, and presentation of data and of statistics. If these tasks are organisational activities that are performed at a clinical workstation, the functions can also be implemented in a PDMS module.

Clinical PDMSs are used to varying degrees in workstation systems in anaesthesia, surgery, and intensive care departments. The characteristics of desktop clinical PDMSs include documentation tasks and also functionalities for diagnostics and therapy (for example see www.e-health-com.eu/fileadmin/user_upload/dateien/Downloads/Gaertner_Software_als_Medizinprodukt_end.pdf). The documentation tasks include functionalities for basic and on-going documentation for a patient, automation of the documentation processes, and query tools for checking patient data and patient parameters.

Diagnostic functionalities include, inter alia, automation of the clinical workflow, compression and display of relevant information for the development and prognosis of a sepsis (associative trends reduce medication errors and improve the reliability for the patient), display of information in graphical form for trends, processing of the monitoring data for further care-related and medical measures, representation of the path from diagnosis to identified goals and the resultant necessary measures, which can be proposed automatically by the system, integration of diagnosis-goal-measure trees as a model corresponding to the care standard provided, measure assistance and documentation for care-related and medical measures, summary and overview of cardiovascular and respiratory data for example, inter alia the use of scores or complex score calculations from physiological scores and care scores, assistance when estimating severities of illness and treatment intensities via scores by automatic establishment of score parameters from the data present and representation in comparison to the previous day, forms and report modules containing statements concerning the quality of treatment and information functions, for example indication of the input of new laboratory values.

The therapeutic functionalities include, inter alia, therapy and care planning, improvement of the quality of care, creation of therapy plans, work easement and quality assurance by means of the compilation of treatment standards, memory and reference functions with regard to deviations and value overshooting, coordination of therapy and care processes, assistance of clinical workflows, adaptation and configuration for specialist departments in order to assist treatment and care processes, full monitoring of the workflows from admission through planning of therapy and care to discharge, individual adaptation of orders, prescriptions and measures for a patient (for example volume specification), recording and monitoring of orders and prescriptions and their implementation (memory function), order and prescription lists for the outlook, analysis and implementation of medical and care-related measures, medication prescription systems (pharmacotherapy), calculation of medication doses, definition of normal values for patients (laboratory values), display of deviations or values that lie outside these ranges, calculation of active ingredient doses and balances, fluid balancing, formula calculations, calculation of the rate/dosage and therefore the adjustment of infusion pumps for liquids and drugs, parameterisation of schedules, use of data analysis tools for the treatment, creation and monitoring of care plans, wound care (wound management) with representation of the state of wounds over time, allergy module with indications and warnings for specific patients with regard to allergies to certain drugs, solutions and certain ingredients, etc., and adaptation of the system to user requirements by means of configuration models.

In addition, the key feature of a clinical PDMS may be the automatic data transfer from the medical devices, such as vital data monitors (monitoring devices), infusion pumps or respiratory devices, in order to represent, to process, to further convey or to store the device data obtained. Clinical PDMSs with automatic data transfer from medical devices and information systems are to be acquired as embedded systems, for example embedded software, for the medical devices specified exclusively by the manufacturer as desktop workstations with product authorisation.

In accordance with the MEDDEV document 2.1/6 of the “Health Technology and Cosmetics Unit” of the European Commission, software modules of which the purpose is primarily the storage and transmission of patient data are not medical devices (for example see ec.europa.eu/health/medical-devices/files/meddev/2_{—}1_{—}6_ol_en.pdf). As soon as these software modules generate additional information that contributes to diagnosis and therapy or that demands diagnostic or therapeutic handling, such as alarms, they are to be classified as medical devices.

Commercial products from manufacturers of medical and clinical information systems with which one or more mobile front-end devices, for example tablet PCs, communicate wirelessly with the installed medical information system are known. The mobile uses of the “Electronic Medical Record” product provided by SAP (www.sap.com) are cited by way of example, by means of which doctors and care staff can access a central information system containing the electronic medical files via mobile front-end devices.

Products and IT systems that assist collaborative healthcare outside acute care are commercially available. These systems also use, inter alia, mobile technologies in order to connect patients and their families to care providers or to a health coach. The SAP Collaborative E-Care Management product is cited by way of example (for example see www.sap.com/germany/industries/healthcare/mobility/pdfs/19239_TL_{—}50112018_deDE.pdf).

Furthermore, wireless communication solutions between the mobile front-end devices and the installed information system are known. The standardised communication solutions include, inter alia, wireless local networks (wireless local area networks or WLANs) or radio systems based on 3^{rd} and 4^{th} generation mobile radio standards, which exchange data via the Internet. Security technologies that connect the mobile subscriber via a secured connection to the information system, for example via a web-based secure-socket layer virtual private network (SSL-VPN), and security technologies for the encryption and pseduonymisation (anonymisation) of patient data that is transmitted or stored are also known.

Applications and development tools with which medical devices for measuring vital parameters, such as blood pressure, weight, temperature and blood glucose, are connected via an in-house web server to mobile front-end devices capable of communication via the Internet are known. This category includes, inter alia, the VitaDock® products by Medisana (www.medisana.com), and also products by Withings (www.withings.com). The applications (apps) currently available are designed for the coupling of the vital parameter devices to mobile front-end devices, capable of communication via the Internet, provided by Apple (www.apple.com). Users receive a user account on an in-house server, on which the vital data individual to each user is stored, and access to the user-specific data is regulated via authentication methods.

From the USA, IT networks are known with which data can be transmitted from wirelessly connected medical devices via a “cloud”-based platform, presented, and stored centrally on a “cloud server”. These products are defined by the American Food & Drug Administration (FDA) as Class 1 medical products and in the category of “Medical Device Data Systems MDDS”. The MDDS “Life 2net™ Platform” by Qualcomm (www.qualcomm.com/solutions/healthcare”) is cited by way of example.

Software products and run-time environments with which medical devices are connected directly via wired or wireless connections to information systems or via a central data server are known. The commercially obtainable system “DataCaptor™” by Capsule™ (www.capsuletech.com/medical-device-software.htm) is cited by way of example. The platform “Capsule Neuron” is sold by the same company, with which the data from the devices and medical information systems connected to the patient is managed and displayed at the bedside in the clinical environment. Data from the medical devices and systems connected to the patient can also be represented on mobile front-end devices at the respective hospital bed in a bed-central manner.

Research projects from the medical field are known, in which the feasibility of the networking and integration of medical devices and medical information systems based on service-oriented architectures (SOAs) and web services in hospitals for surgical interventions is examined. By way of example, these projects include the scheme “Sanftes Operieren mit innovativen Techniken” (SOMIT, 2005-2011) requested by the BMBF, in which the research associations FUSION and OrthoMIT examine the integration of electromedical device systems for applications in the OP (see Strähle, M.; Ehlbeck, M.; Prapavat, V.; Kück, K.; Franz, F.; Meyer, J.-U. Towards a Service-Oriented Architecture for Interconnecting Medical Devices and Applications, Proceedings 1st Joint Workshop On High Confidence Medical Devices, Software, and Systems (HCMDSS) and Medical Device Plug-and-Play (MD PnP) Interoperability. Cambridge, Mass., USA. Jun. 25-27, 2007. Boston.). For implementation of the SOAs, a selection of web service specifications were used, advantages and disadvantages of central and decentral service architectures were analysed, and a risk analysis according to IEC standard 80001 was performed. For a summary of the current state of science with regard to the use of service-oriented structures and web services in hospitals, see Meyer, Jörg-Uwe. Vernetzte Medizingeräte mit medizinischen IT-Systemen für integrierte intraoperative diagnostische and therapeutische Abläufe. Endoskopie Heute. Georg Thieme Verlag K G. Stuttgart; New York. December 2011. edition 4, pages 265-270.

Patent application US 2006/0100746 A1 discloses a system for transmitting medication data and a method for infusions for patients. The patent application describes a superordinate system that connects a PDMS web server to bedside PDMSs with connected pumps, a drug information system, a system for prescribing drugs, and an information system of a clinical department with desktop memory unit. Furthermore, the patent application discloses a method with which the name of a specific drug for infusions is associated via a central PDMS web server with a specific infusion pump at the patient's bed and is presented at the bedside on the local PDMS monitor.

The patent application does not, however, provide any modular system configuration in which clients can communicate via standardised interfaces and exchange formats with the PDMS web server in a network.

Patent application DE 10 2008 044 726 A1 discloses a method for optimising work processes in the clinical field, wherein automated procedures are controlled via a central PDMS web server and sensor-based or workflow-based events are detected from the environment in order to reduce the manual intervention and the interaction of human resources with the PDMS.

The patent application describes a partial aspect of simplified manual user interaction.

Patent application DE 10 2009 022 852 A1 discloses a medical system that comprises at least two data-processing medical devices and information systems and one integration server. A data-based functionality of the respective device is characterised as a data interface in the form of a web service that is networked to an integration server via an enterprise service bus in the manner of an SOA. Due to a simpler integration of devices, improved workflows and shorter intervention times on patients are to be achieved.

Known PDMS modules are designed as PC desktop application programs (applications) or as independent software for a workstation and are normally registered and licensed per workstation installation. The binding of a PDMS to the locality of a workstation exists particularly for clinical PDMSs, which, as embedded software, transfer data from medical devices that are located at the workstation. A fixed link, bound to the location, between the locally arranged and networked medical devices and the embedded PDMS workstation software is thus created at the same location. Due to the close link between the PDMS and the software of the medical devices for automatic data transfer, changes to the PDMS software and to the database structures have a direct effect on the interface to the medical devices of generally limited predictability as to whether a fault-free data exchange will be maintained. Installation and maintenance are additionally designed for specific computer operating systems, versions and memory capacities, and can therefore cause a conflict with other installations when executed. There is normally a rigid dependence of technical resources with the applications. In order to satisfy as many requirements as possible, technical resources are generally overspecified. In order to cope with a large number of applications, conventional PDMS software modules offer a multiplicity of functionalities independently of the need of the individual user. This often leads to impaired operability and to an unnecessary complexity when using the system. Scalability and re-configurability are highly limited, inter alia also due to the necessary complex and static database structures of these systems. The creation and write-offs of these systems are bound to fixed periods of time, which can prevent flexible use of the systems in accordance with the current need. No PDMS web application is known that is designed as an independent client server system. With the conventional PDMS modules, there is also the disadvantage that the integration of PDMS modules in computer networks and in the web can normally only be implemented via extra servers designed for this purpose, or what are known as gateway servers.

With known PDMS modules, templates and data content are stored statically in a database. Since the databases of the known PDMS modules are not connected directly to a web server, the handling and the presentations of the data does not allow any interpretation by server technology, such as ASP, JSP or PHP. The known PDMS modules have therefore proven to be disadvantageous as soon as the scope of the integrated applications increases, the complexity of the data relations to one another rises, and at the same time the updating cycles with continuously changing data reduce. In addition, the storage of patient data is subject to strict guidelines and regulations, the observance of which is to be proven and demonstrated to the control authorities in highly complex methods.

If a PDMS module generates additional information that contributes to diagnosis and therapy or that demands diagnostic or therapeutic handling, it is to be classified as a medical device or medical system. A PDMS module that manages data from networked medical devices and medical information systems and/or controls this system is to be classified as a medical system as soon as it is used in a manner designed for diagnosis and therapy. In accordance with the new ISO standard 80001 from 2010, operators of systems formed of linked medical devices and information systems, as responsible organisations, must take into consideration the risk of these medical IT networks and systems with regard to patient security, data security and efficacy, and provision must be made for a quality management system. Due to the above-described rigid and generally complex dependences of the technical resources with the numerous applications and the manufacturer-specific interfaces, there is the disadvantage for the operator of known PDMS systems to verify and to validate the complex systems for all possible functionalities and at the same time to demonstrate the data security of the application and the security of the data storage before and during operation.

With known PDMS modules, it has proven to be disadvantageous that development, maintenance and service tasks of known medical IT networks from afar are impaired since developers, IT administrators and service technicians do not have direct web access to the network and the connected modules and components thereof.

### OBJECT OF THE INVENTION

The object of the present invention is therefore to provide an improved VDMS, for example a PDMS.

### GENERAL DESCRIPTION OF THE INVENTION

One aspect of the invention relates to a medical vital data management system (VDMS), for example a patient data management system (PDMS), comprising a VDMS web application 1 of a run-time environment.

In accordance with this aspect of the invention, the VDMS has a unique web domain address and can be used as a virtual machine (VM).

A further aspect of the invention relates to a VDMS, wherein the VDMS web application 1 comprises a web server 2 and a database.

In accordance with this further aspect of the invention, the web server 2 is coupled directly or via a database interface component 5 to the database 3, which together form the VDMS web application 1 of a domain. The VDMS run-time environment of the VDMS web application 1 can be designed such that it executes applications as a virtual machine. The VDMS web application 1 becomes an independent virtual machine for applications and processes that can be hosted by an external provider of computing environments. The VDMS module, as an independent VDMS web application of a run-time environment, can thus execute applications with use of a client server architecture in a virtualised manner.

This aspect of the invention provides the advantage that no additional special gateway server has to be designed and created for the respective VDMS module. Since the VDMS application 1 is operated as a virtual machine or virtual network (VN), there is the advantage from the user's point of view that no additional computing capacities have to be provided and no additional programs have to be installed. The interactions of the VDMS web server 2 with the user and client can be implemented via browser inputs. The VDMS web application 1 is available to the user as “software as a service” (SaaS). SaaS services offer the users the advantage that no operating-system-specific installations on local computers and computer workstations are necessary, since the computing capacities are virtualised. Furthermore, “pay-per-use” concepts can be easily implemented by SaaS services. In addition, the user can assume that the provider of the VDMS SaaS is responsible for keeping the software up to date and that upgrades can be performed by the provider of the VDMS software without interactions on the part of the user or the IT administrator that operates the application.

A further aspect of the invention relates to a VDMS, wherein the database is a transient database 3.

In accordance with this further aspect of the invention, the data is held transiently in the database 3 and is only made available for the period of the treatment 4, which is necessary for execution and documentation of the applications 11. The database 3 is filled and emptied via a database interface 5, which is directly connected to the VDMS web server 2. The transient database 3 is filled with data from external data sources, for example medical devices 13, sensor systems 13 and information systems 15, via the web service communication interface 9 of the integration engine 6 of the VDMS web server 2 on the basis of standardised protocols for the exchange of data and services 12. The http-/https-based data exchange occurs via web services (WSs) 12 with use of simple object access protocol (SOAP) and/or represential state transfer (REST) message formats. The data sources act as “service providers” for services that are consumed by the communication environment of the VDMS web server 2. Web services 12 and the web service communication interface 9 of the integration engine 6 are also used for the emptying of the data held and buffered in the transient database 3. The data generated from the applications for treatment of the patient 23 is held in the transient database 3 of the VDMS web application 1 until it is distributed among the connected data sinks in accordance with predefined rules. In this process, the web service communication interface 9 of the VDMS web server 2 takes on the role of the “service provider”, and the data sink takes in the role of the “service consumer”. Inter alia, connected medical devices 13, vital sensor systems 13, and medical workstations 13, other devices and systems 14, and also medical information systems and databases 15 count as possible data sinks. Contents of the transient database 3 are deleted once the applications 11 of the web application have been executed. The transient database 3 can be configured as a cache, which is used as a quick data buffer and intermediate memory, so as to avoid renewed access to the data sources, which are slow to respond in part, or complex recalculations. The cache is also used to buffer the data generated during the treatment until data is distributed in external data sinks. Content and data that has already been created and calculated once remains in the cache, such that it is available more quickly as required subsequently by the VDMS web application 1. Data from data sources can also be requested from data sources before use and can be provided beforehand in the cache of the browser. Due to the management exclusively of the data that is required for the care of patients in the treatment period 4, there is the additional use that the quantity of data and therefore the required data memory size is restricted to a minimum and therefore the working memory of the cache is not loaded unnecessarily. The small data quantities per time additionally promote the quick data exchange between the browser interface of the client front-end devices 21, 22, the representation engine 7 from the presentation layer 16, the integration engine 6 from the application layer 17 of the web server 2, and the database interface component 5 of the transient database 3 from the persistence layer 18. The database structure of the VDMS module is therefore designed in such a way that the web server 2 can have a direct influence on the data structure, data streams and data storage in the database 3, and that data is only integrated and held over a specific period of time for the execution of applications, this period of time being the period necessary for the treatment and care of the patient 23 in the treatment period. The web server 2 communicating with external data sources and data sinks can (exclusively) synchronise and orchestrate data and data streams of the partly parallelised applications, which are used to carry out the treatment in the run-time environment. The VM of the VDMS can be constructed such that it controls the data streams of the networked systems similarly to a hub. In addition, the VDMS only needs to provide the data with which activities of an event within a finite period of time can be processed in accordance with predefined workflows.

Since the VDMS web server 2 only deals with patient data for the time of the operation of the medical IT network and the data buffer of the VDMS web server 2 is emptied again after operation, no patient data remains on the front-end client devices 21, 22 of the users 25, 26. This results in the advantage that, in the event of a device becoming lost, there is no risk that unauthorised individuals can access the patient data on the device. Due to its system and operating architecture, the medical VDMS module therefore makes a contribution to patient data security and to the protection of the patient's privacy.

A further aspect of the invention relates to a VDMS, wherein the VDMS web application 1 is designed as a server, medical devices 13, systems 14, 15 and/or operating devices 21, 22 are configured as clients, and the server and the clients form a medical VDMS IT network.

In accordance with this further aspect of the invention, the medical VDMS module is designed as a modular medical IT network that can be configured in an ad-hoc manner, wherein the web server 2 communicates by means of the web service communication interface 9 of the integration engine 6 with connected devices, systems and servers 13, 14, 15, which are configured in the network as clients. The “VDMS engine” is configured by the VDMS system administrator such that, before the start of treatment, networks are only constructed with the clients that were previously known and of which the technical compatibility with the network and interoperability of the application has been verified and checked in advance. Since the VDMS web application 1 is assigned a unique URL web address, “thin clients”, for example mobile front-end devices 21, 22 with Internet connection and browser GUI, can achieve direct connection to the VDMS web server 2 with use of a proxy mechanism via a secured virtual private network (VPN). This process promotes the ad-hoc construction of a secured VDMS network, in which external medical devices and systems 13, 14, and mobile operating units and front-end devices 21, 22 are networked with the VDMS web server 2. The clients of the operating units 21, 22 are configured such that they communicate with the graphic-creating run-time environment 7 of the VDMS web server 2 via standardised http/https protocols. The external devices and systems 13, 14, 15 are configured as clients that exchange SOAP and/or REST messages 12 in the form of web services with the service endpoints of the VDMS web server 2. Authorised actors 25, 26 can exchange http-/https-based data with the “view engine” 7 of the VDMS web server 2 via the specifically adapted browser GUIs of the front-end devices 21, 22. Inter alia, IT administrators 25, the medical service providers 26 using the network, the risk manager stipulated in IEC standard 80001, and individuals authorised to verify and validate the medical IT network in the run-time environment count as authorised actors 25, 26.

The architecture of the medical VDMS module is thus designed such that, in a client-server configuration, it forms an IT network for medical applications, it being possible to design said IT network in a modular manner. The connected clients communicate via standardised web protocols and secure connections with the VDMS web server 2. The run-time environment of the VDMS web application 2 is designed such that it enables the formation of ad-hoc networks. The medical IT network formed of medical devices 13, which are connected to the patient 23 during the treatment, and the connected information systems are designed such that they assist the user of the network when performing his tasks. The VDMS network contributes to making the treatment of patients more effective and quality-assured, to carrying out administrative tasks more efficiently, and to ensuring the quality of the treatment. Furthermore, the medical IT network can be designed such that the functionalities of the individual network components and the cooperation of the components with other network components can be verified and checked in the run-time environment of the VDMS web server 2, independently of location.

The capability of the VDMS web application 1 to form a medical IT network that can be configured in an ad-hoc manner via standardised interfaces exclusively to known external network components thus provides the advantage, from the point of view of the user and provider of medical services, that said user and provider can determine the functional capability of the medical IT network in a type of system check without prior technical knowledge. The user or provider is thus able to itself check and document the technical security of the system connected to the patient 23. Processes and process steps that are associated with the processing of data from connected devices and systems are thus simplified, to the extent that the processes are implemented in an automated manner and the user is reminded of necessary interactions via the browser GUI of the client. The user connected to the network can check, during operation of the system, the correct execution of the processes with regard to patient care, since the VDMS network immediately provides feedback concerning correctly executed processes. The described sequences of the system review make the user of the VDMS network capable of conducting documented risk management during operation of the VDMS network, without increasing the work effort. As a result, the automated sequences of the VDMS network in cooperation with the automated interactions of the user increase the security for the patient 23 connected to the network. From the point of view of the risk manager for medical IT networks, there is the advantage that only clients of which the technical compatibility with the network and the interoperability of the applications have been verified and checked in advance in the actual run-time environment form an IT network with the VDMS web server 2. The VDMS network thus contributes to the security of the network operation for the user and patient 23.

Furthermore, the design of the VDMS web application 1 as a client-server installation offers the advantage that authentication and authorisation procedures with the registration of the actors takes place exclusively in the domain of the VDMS web application 1. The subscribers in the VDMS network are known before operation of the network and are exclusive. Security concepts with respect to the unpermitted access to the network are thus easier to implement. In addition, there is the security aspect that the operability and integrity of the network formed on an ad-hoc basis is checked before each treatment. The exclusive participation of system-known clients and actors in the client-server VDMS network constellation and the possibility of designing the VDMS network as a VM in an exclusive cloud environment promote the acceptance of the VDMS as an SaaS service product.

A further aspect of the invention relates to a VDMS, wherein the web server 2 comprises an integration engine 4 in order to integrate and synchronise data, services, applications and processes.

Data can thus be integrated from client applications running simultaneously and can be assigned to the processes of the applications of the PDMS network.

A further aspect of the invention relates to a VDMS, wherein the integration engine 6 of the web server 2 comprises a web service communication interface 9 in order to exchange SOAP and/or REST messages 12 between an endpoint of the web server 2 and the clients 13, 14, 15.

Data is thus exchanged via the web between the system clients and the web server on the basis of standardised protocols and interfaces.

A further aspect of the invention relates to a VDMS, wherein the integration engine 6 of the web server 2 comprises a workflow engine 10 in order to model processes of applications and to orchestrate them among one another.

A further aspect of the invention relates to a VDMS, wherein the VDMS web application 1 can be reached by remote access.

In accordance with this further aspect of the invention, the run-time environment of the VDMS application is itself used for web application by the client server architecture of the VDMS network. The run-time environment of the VDMS is assigned a unique web address, via which the VDMS network and connected clients can be reached as known components of the VDMS network via remote access. The secure remote access to the VDMS web application 1 is achieved in that there is a secured VPN connection to the web server 2, which itself thus adopts the function of a “clientless SSL-VPN”. An advantage is that controlled web access to the VDMS network is achieved remotely, whilst maintaining security mechanisms. Applications can thus be created that make it possible, outside the treatment period, to technically maintenance, to service and to manage the VDMS network remotely.

Authorised IT administrators, system users, developers and technicians 25 can thus access the VDMS network and the networked technical modules of the VDMS network remotely, but without having to obtain direct access to the company network in which the VDMS network is incorporated.

A further aspect of the invention relates to a VDMS, wherein desktop front-end devices 21 and/or mobile front-end devices 22 are coupled to browser GUIs as clients via the web 20 at a graphic engine for web frontends 7.

In accordance with this further aspect of the invention, the graphic engine for web frontends 7 assists the representation of current data and the operation via the browser GUI.

A further aspect of the invention relates to an information technology device of a VDMS, comprising a VDMS web application 1 of a run-time environment.

A further aspect of the invention relates to a computer program product, wherein the computer program product comprises a computer program that is stored on a data storage medium or on a memory of a computer and that comprises commands readable by the computer, which are intended for execution of the method in accordance with one of the above-mentioned aspects when the commands are executed on the computer.

A further aspect of the invention relates to an automated vital data management system (VDMS). The automated VDMS comprises a (web) addressable server system 1 with transient database and communicates via integrated, automated sequences (engines) with a number of client systems parallel and on-line in a network, wherein at least one client system 13 is coupled to a living system 23 such that interactions between the at least one client system 13 and the living system can be detected. There are four categories of networked client systems that are necessary for the function of the virtualised VDMS (VDMS):

1) The VDMS 1 comprises at least one client vital system 13. The VDMS 1 may also contain a number of client vital systems 1 however, of which the activities are automated among one another and are synchronised and implemented in accordance with predefined rules.
2) The VDMS comprises at least one client browser GUI front-end device 21, 22, with which data streams of the VDMS 1 can be represented and controlled during the run-time 4. The VDMS may also comprise a number of client browser GUI front-end devices 21, 22 however, with which users can regulate their individual, assigned data streams interactively, independently of simultaneous use of the VDMS by the other users of the further networked client browser GUI front-end devices 21, 22 of the VDMS.
3) The VDMS 1 may comprise at least one client sensor actor system 14, which is not coupled to a living system and which performs a sensor-based and/or actor-based function in the network, said function controlling the VDMS 1. The VDMS 1 may also comprise a number of client sensor actor systems however.
4) The VDMS 1 may comprise a client data information system 15, which serves as a data source (data provider) or data sink (data memory, data consumer) of the generated and integrated data. The VDMS 1 may also comprise a number of data information systems however. If, in order to achieve the intended purpose, the VDMS 1 comprises no client data information systems 15, data is lost after termination of functional interaction with the living system 23 or once a time default for an execution period has been reached. The data content of the transient database 3 is emptied once the predefined run-time 4 has elapsed.

The automated VDMS can also be used for tasks and modes in which the living system 23 is not coupled to a client vital system 13. In a non-vital mode, data streams are represented and controlled via the client browser GUI front-end device 21, 22 in a manner individual to each user 25, 26, for example in order to handle tasks relating to administration, development, maintenance, simulation, execution of a test or verification, or provision of personalised electronic services.

Further aspects of the invention relate to corresponding devices, methods, systems and computer program products for IT-based patient data management and for automated compilation and processing of vital data.

Aspects of the invention can be combined.

### BRIEF DESCRIPTION OF THE FIGURES

The features, advantages and alternative embodiments of examples of the invention will be described in the following detailed description with reference to the accompanying FIGURE, in which similar reference signs denote similar elements.

In the FIGURE:

FIG. 1 shows a schematic illustration of a medical patient data management system in accordance with a preferred embodiment of the invention.

### DETAILED DESCRIPTION OF THE EMBODIMENTS

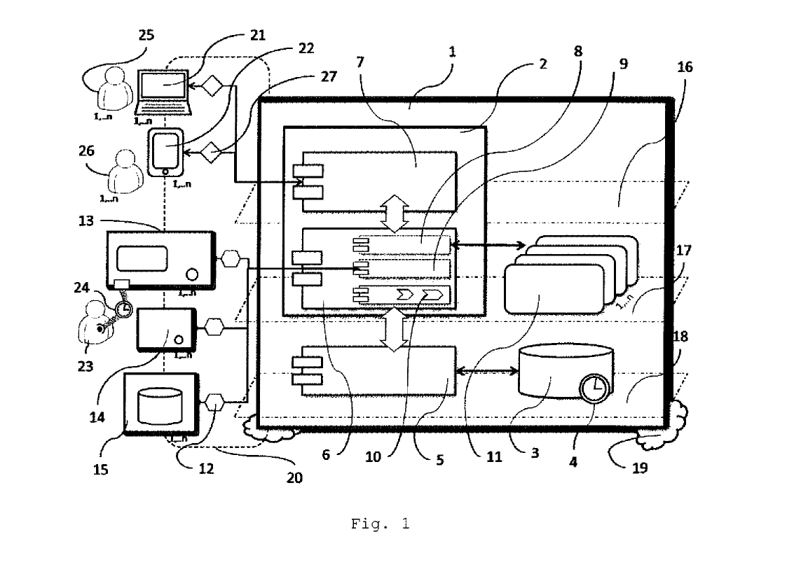

FIG. 1 shows a schematic illustration of a medical patient data management system (PDMS) comprising technical components and the relationship thereof relative to one another in accordance with a preferred embodiment of the invention. The PDMS comprises a PDMS web application 1 comprising a web server 2 and a transient database 3. The transient database 3 communicates for the run-time of a program 4 via a database interface component 5 with an integration engine 6 of the web server 2. Integration and buffering of data in the transient database 3, said data being required and generated only for one application and treatment, is thus enabled. Furthermore, automatic emptying of the data compiled during the treatment from the transient database 3 in connected systems and data memories outside the domain is enabled in accordance with predefined rules. The integration engine 6 is used for integration of data and applications. Furthermore, the integration engine 6 communicates with a dynamic graphic engine 7 or web frontend engine of the web server 2 for graphical representation of data and documents generated during the run-time. The integration engine 6 comprises, as sub-components, an applications engine 8, a web service communication interface 9, and/or a workflow engine 10. The applications engine 8 orchestrates and synchronises the applications 11 (applications or programs), which are processed in the run-time 4. The applications can thus be executed in an automated manner in the domain of the run-time environment in accordance with fixed rules and process sequences. The web service communication interface 9 of the web server 2 serves as an endpoint of the web service 12 by means of which messages are exchanged on the basis of simple object access protocol (SOAP) and/or represential state transfer (REST) with web service clients 13-15. The PDMS web application 1 can be constructed in a conventional manner in a 3-layer architecture. A presentation layer 16 with the frontend engine 7, an applications layer 17 with components of the integration engine 6, 7, 8, 9 and a persistence layer 18 with the database interface component 5 and the transient database 3 form the architecture of the PDMS web application 1. The aforementioned components of the run-time environment of the PDMS web application 1 are adapted to one another, preferably with use of standardised development tools, such that the PDMS web application 1 can be constructed as a virtual machine, which preferably operates on a host computer in a platform-independent manner. The integrated run-time environment of the PDMS web application 1 is thus suitable for an exclusive “cloud computing” implementation 19 and for “software as a service” (SaaS) service offers. Since the PDMS web application 1 can be assigned a uniform resource locator (URL, unique web address, unique IP address), the clients 13, 14, 15, 21, 22 can achieve direct connection to the PDMS web server 2 with access to the internet/web 20, for example via a secured VPN.

The PDMS web application 1, as a virtual machine, can thus execute program instructions of a client server network on a host computer in an automated manner. The web applications are used for example for the documentation of a treatment and, in accordance with the intended purpose, provide diagnosis and/or therapy function for the user on a browser interface. A managed diagnosis and/or therapy function can thus be provided via the integrated workflow engine.

FIG. 1, on the left-hand side, shows clients 13, 14, 15, 21, 22, which together with the PDMS web application 1 form the medical PDMS. The clients 13, 14, 15 are characterised in that they, as independent, generally electrical or electronic systems, can convert signals independently of a network connection and can process information in a purpose-oriented manner and can therefore be referred to as “rich clients”. In the PDMS, medical devices and sensor systems 13 for measuring the vital status of the patient 23, non-medical devices or electronic systems 14 and external information systems and databases 15 outside the domain of the PDMS web application 1 can be counted as “rich clients”. Automatic data transfer and compilation of external data from medical devices and sensors and also from medical information systems and database systems is thus enabled.

The medical devices and vital sensor systems can interact for the duration of the treatment process 24 with the patient during the run-time 4 of the PDMS. The “rich clients” 13, 14, exchange data and documents beforehand via web services 12 with the endpoints of the PDMS web server 2.

Desktop front-end devices 21 and mobile front-end devices 22 belong to a further category of clients of the PDMS. The front-end devices 21, 22 are operated by technical (IT) users 25 of the PDMS and by healthcare providers 26, preferably via a graphical user interface (GUI), for example a browser GUI. The front-end devices 21, 22 are connected for example via the Internet/web 20 to the frontend run-time component 7 of the web server 2. The data exchange 27 between the front-end devices 21, 22 and the PDMS web server 2 can take place for example on the basis of the secured hypertext transfer protocol HTTPS.

Generally, the method according to the invention may be executed on a stationary or mobile device and/or on one single computer or on several computers that are linked over a network. The computers may be general purpose computing devices in the form of a conventional computer, including a processing unit, a system memory, and a system bus that couples various system components including system memory to the processing unit. The system bus may be any one of several types of bus structures including a memory bus or a memory controller, a peripheral bus and a local bus using any of a variety of bus architectures, possibly such which will be used in image processing system environments. The system memory includes read-only memory (ROM) and random access memories (RAM). A basic input/output system (BIOS), containing the basic routines that have the functionality to transfer information between elements within the computer, such as during start-up, may be stored in one memory. Additionally, the computer may also include hard disc drives and other interfaces for user interaction. The drives and their associated computer-readable media provide non-volatile or volatile storage of computer executable instructions, data structures, program modules and related data items. A user interface may be a keyboard, a pointing device or other input devices (not shown in the figures), such as a microphone, a joystick, a mouse. Additionally, interfaces to other systems might be used, such as an interface to a database or a central server. These and other input devices are often connected to the processing unit through a serial port interface coupled to system bus. Other interfaces include a universal serial bus (USB). Moreover, a monitor or another display device is also connected to the computers of the system via an interface, such as video adapter. In addition to the monitor, the computers typically include other peripheral output or input devices (not shown), such as speakers and printers or interfaces for data exchange. Local and remote computer are coupled to each other by logical and physical connections, which may include a server, a router, a network interface, a peer device or other common network nodes. The connections might be local area network connections (LAN) and wide area network connections (WAN) which could be used within intranet or Internet. Additionally networking environment typically includes a modem, a wireless link or any other means for establishing communications over the network.

Moreover, the network typically comprises means for data retrieval, particularly for accessing data storage means like archives, memories, repositories and the like. Network data exchange may be coupled means of the use of proxies and other servers.

It has to be pointed out that the method changes and transforms physical subject matter. There is provided a novel architecture and a computer-based platform for a vital data management system, which allows integration of mobile end devices, communicating over networks, such as the internet. Further, the physical architecture of the computer-based devices has been changed compared to normal devices of state of the art systems, as the interface and communication structure are adapted for mobile access and comprise a virtualization of patient data management functions.

### LIST OF REFERENCE SIGNS

1 vital data management system (VDMS) web application, e.g. patient data management system (PDMS) web application
2 web server
3 transient database
4 run-time of engines
5 database interface component
6 Integration engine
7 dynamic graphic engine for web frontends
8 applications engine, e.g. web applications engine
9 web service communication interface
10 workflow engine
11 applications
12 web service data exchange (e.g. based on SOAP or REST messages)
13 medical device, sensor system for measuring vital status
14 non-medical device, electronic system
15 external information system or database
16 presentation layer
17 application layer
18 persistence layer (with transient database)
19 exclusive cloud
20 Internet/web
21 desktop front-end device (with web browser GUI)
22 mobile front-end device (with web browser GUI)
23 patient, living system
24 vital connection (during measurement and treatment period)
25 user or administrator of technical VDMS IT network
26 healthcare professional
27 data exchange (e.g. http or https based)

1. A vital data management system (VDMS), comprising:
a VDMS web application of a run-time environment.

2. The vital data management system according to claim 1, wherein:
the VDMS web application comprises a web server and a database.

3. The vital data management system according to claim 1, wherein:
the VDMS web application is designed as a server,
medical devices, systems and/or operating devices are configured as clients, and
the server and the clients form a medical VDMS IT network.

4. The vital data management system according to claim 2, wherein:
the web server comprises an integration engine in order to integrate and synchronise data, services, applications and processes.

5. The vital data management system according to claim 4, wherein:
the integration engine of the web server comprises a web service communication interface in order to exchange SOAP and/or REST messages between an endpoint of the web server and the client.

6. The vital data management system according to claim 4, wherein:
the integration engine of the web server comprises a workflow engine in order to model processes of applications and to orchestrate these among one another.

7. The vital data management system according to claim 1, wherein:
the VDMS web application can be reached by remote access.

8. The vital data management system according to claim 1, wherein:
desktop front-end devices and/or mobile front-end devices are coupled to browser GUIs as clients via the web at a graphic web frontends engine.

9. The vital data management system according to claim 1, wherein the vital data management system is used as virtual machine.

10. An IT-based device of a vital data management system, comprising:
a VDMS web application of a run-time environment.

11. A computer program product, wherein the computer program product comprises a computer program that is stored on a data storage medium or on a memory of a computer and that comprises commands readable by the computer, said commands being intended to execute the method according to claim 1 when the commands are executed on the computer.

12. The vital data management system according to claim 2, wherein the database is a transient database.

13. The vital data management system according to claim 5, wherein:
the integration engine of the web server comprises a workflow engine in order to model processes of applications and to orchestrate these among one another.
